(19) United States
(12) Patent Application Publication
(10) Pub. No.: US 2021/0164707 A1
(43) Pub. Date: Jun. 3, 2021

(54) MECHANICAL DEVICE AND OPERATING METHOD THEREOF

(71) Applicant: Wei-Sung WENG, New Taipei City (TW)

(72) Inventor: Wei-Sung WENG, New Taipei City (TW)

(21) Appl. No.: 17/107,581

(22) Filed: Nov. 30, 2020

(30) Foreign Application Priority Data
Dec. 2, 2019 (TW) 108143930

(51) Int. Cl. F25B 29/00; F25B 5/04; F25B 49/02

(52) U.S. Cl. CPC F25B 29/003; F25B 5/04; F25B 2700/2115; F25B 2341/0661; F25B 2600/2513; F25B 49/02

(57) ABSTRACT

A mechanical device includes a working medium, a hot end, a cold end, and first and second volume regulating units. The hot and cold ends are in thermal contact with the working medium during circulation thereof. The first and second volume regulating units are disposed between the hot and cold ends, and are configured to allow passage of the working medium therethrough to perform compression and expansion of the working medium. The volume of the working medium exiting the first volume regulating unit differs from that of the working medium entering the second volume regulating unit. The volume of the working medium entering the first volume regulating unit differs from that of the working medium exiting the second volume regulating unit.

### CROSS-REFERENCE TO RELATED APPLICATION

This application claims priority of Taiwanese Patent Application No. 108143930, filed on Dec. 2, 2019.

### FIELD

The disclosure relates to a mechanical device, and more particularly to a mechanical device, which is approximate to a Carnot heat engine or heat pump, and an operating method thereof.

### BACKGROUND

The Carnot cycle is a theoretical thermodynamic cycle working between two constant-temperature heat reservoirs (i.e., hot and cold reservoirs), and consists of two reversible isothermal processes and two reversible adiabatic (or isentropic) processes. A Carnot heat engine (or heat pump) that operates on the Carnot cycle (or reversed Carnot cycle) provides an upper limit on the efficiency of real thermodynamic engines. However, in reality, there are few thermodynamic engines efficient enough to approximate to the Carnot heat engine.

### SUMMARY

Therefore, the object of the disclosure is to provide a mechanical device and an operating method thereof that can approximate to a Carnot heat engine.

According to a first aspect of the disclosure, a mechanical device includes a working medium, a hot end, a cold end, a first volume regulating unit and a second volume regulating unit.

The working medium is configured to circulate along a circulation path. The hot end is in thermal contact with the working medium during the circulation thereof. The cold end is in thermal contact with the working medium during the circulation thereof. A temperature of the cold end is lower than a temperature of the hot end.

The first volume regulating unit is disposed between the hot and cold ends, and is configured to allow passage of the working medium therethrough to perform one of compression and expansion of the working medium during the circulation thereof.

The second volume regulating unit is disposed between the hot and cold ends, and is configured to allow passage of the working medium therethrough to perform the other one of compression and expansion of the working medium during the circulation thereof.

During a cycle of circulation of the working medium, a volume of the working medium exiting the first volume regulating unit differs from a volume of the working medium entering the second volume regulating unit, and a volume of the working medium entering the first volume regulating unit differs from a volume of the working medium exiting the second volume regulating unit.

According to a second aspect of the disclosure, an operating method for a mechanical device includes the following steps:

(a) operating a first volume regulating unit for moving a first volume of a working medium from the first volume regulating unit into thermal contact with a hot end, and simultaneously operating a second volume regulating unit for moving a second volume of the working medium from the hot end into the second volume regulating unit, such that a second volume is greater than the first volume, so as to expand the working medium during thermal contact with the hot end for heat exchange;

(b) operating the second volume regulating unit for expanding the working medium in the second volume regulating unit;

(c) operating the second volume regulating unit for moving a third volume of the working medium from the second volume regulating unit into thermal contact with a cold end, and simultaneously operating the first volume regulating for moving a fourth volume of the working medium from the cold end into the first volume regulating unit, such that the fourth volume is smaller than the third volume, so as to compress the working medium during thermal contact with the cold end for heat exchange; and

(d) operating a first volume regulating unit for compressing the working medium in the first volume regulating unit.

According to a third aspect of the disclosure, an operating method for a mechanical device includes the following steps:

(a) operating a second volume regulating unit for compressing a working medium in the second volume regulating unit;

(b) operating the second volume regulating unit for moving a first volume of the working medium from the second volume regulating unit into thermal contact with a hot end, and simultaneously operating a first volume regulating unit for moving a second volume of the working medium from the hot end into the first volume regulating unit, such that the second volume is smaller than the first volume, so as to compress the working medium during thermal contact with the hot end for heat exchange;

(c) operating the first volume regulating unit for expanding the working medium in the first volume regulating unit; and

(d) operating the first volume regulating unit for moving a third volume of the working medium from the first volume regulating unit into thermal contact with a cold end, and simultaneously operating the second volume regulating unit for moving a fourth volume of the working medium from the cold end into the second volume regulating unit, such that the fourth volume is greater than the third volume, so as to expand the working medium during thermal contact with the cold end for heat exchange.

### BRIEF DESCRIPTION OF THE DRAWINGS

Other features and advantages of the disclosure will become apparent in the following detailed description of the embodiments with reference to the accompanying drawings, of which:

FIG. 1 is a schematic diagram of a first embodiment of a mechanical device according to the disclosure, illustrating relationships between a hot end, a cold end, a first volume regulating unit, a second volume regulating unit and a transmission unit;

FIG. 2 is a schematic diagram illustrating a step of near-isothermal expansion of an operating method for the first embodiment;

FIG. 3 is a schematic diagram of the first embodiment illustrating a first controller that controls a first outer tube valve, a second outer tube valve, a first inner tube valve, and a second inner tube valve, and a second controller that controls a third outer tube valve, a fourth outer tube valve, a third inner tube valve and a fourth inner tube valve;

FIG. 4 is a schematic diagram illustrating the first embodiment being operated on a cycle approximating to the Carnot cycle;

FIG. 5 is a schematic diagram illustrating a step of near-adiabatic expansion of the operating method for the first embodiment;

FIG. 6 is a schematic diagram illustrating a step of near-isothermal compression of the operating method for the first embodiment;

FIG. 7 is a schematic diagram illustrating a step of near-adiabatic compression of the operating method for the first embodiment;

FIG. 8 is a schematic diagram illustrating the first embodiment being operated on a cycle approximating to the reversed Carnot cycle;

FIG. 9 is another schematic diagram illustrating the first embodiment being operated on the cycle approximating to the reversed Carnot cycle;

FIG. 10 is a schematic diagram illustrating a step of near-adiabatic compression of the operating method for the first embodiment;

FIG. 11 is a schematic diagram illustrating a step of near-isothermal compression of the operating method for the first embodiment;

FIG. 12 is a schematic diagram illustrating a step of near-adiabatic expansion of the operating method for the first embodiment;

FIG. 13 is a a schematic diagram illustrating a step of near-isothermal expansion of the operating method for the first embodiment;

FIG. 14 is a perspective view of a second embodiment of the mechanical device according to the disclosure;

FIG. 15 is an exploded perspective view of the second embodiment;

FIG. 16 is another exploded perspective view of the second embodiment;

FIG. 17 is a sectional view taken along line XVII-XVII in FIG. 14;

FIG. 18 is a sectional view taken along line XVIII-XVIII in FIG. 14;

FIG. 19 is a sectional view taken along line XIX-XIX in FIG. 14;

FIG. 20 is a fragmentary sectional view taken along line XX-XX in FIG. 14; and

FIG. 21 is a schematic diagram of a third embodiment of the mechanical device according to the disclosure.

### DETAILED DESCRIPTION

Before the present disclosure is described in greater detail, it should be noted that where considered appropriate, reference numerals or terminal portions of reference numerals have been repeated among the figures to indicate corresponding or analogous elements, which may optionally have similar characteristics.

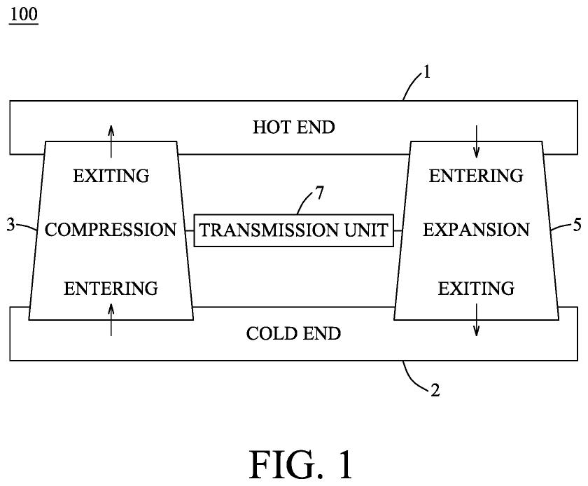

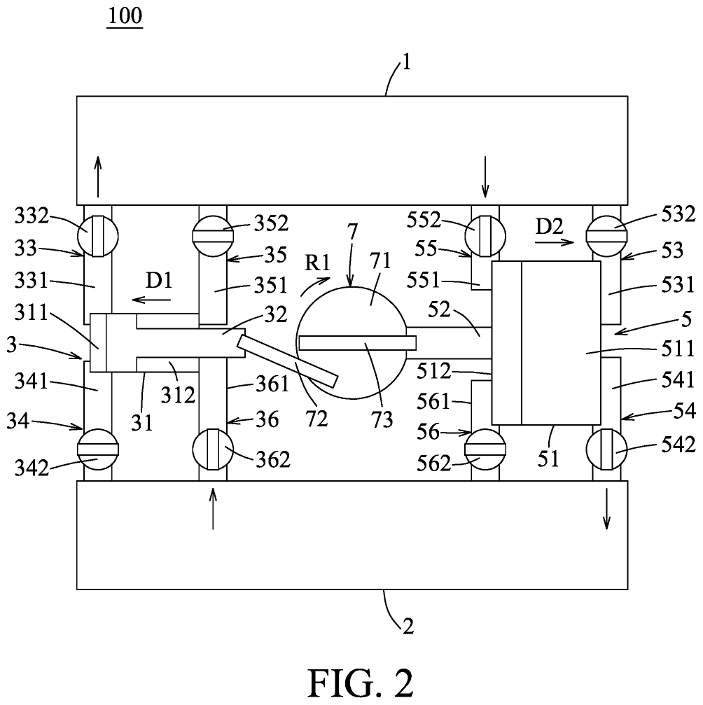

Referring to FIGS. 1 and 2, a first embodiment of a mechanical device 100 according to the disclosure is an external combustion engine that operates on a closed cycle. The mechanical device 100 includes a working medium (not shown), a hot end 1, a cold end 2, a first volume regulating unit 3, a second volume regulating unit 5 and a transmission unit 7.

The working medium is configured to circulate along a circulation path. Under operational condition, the working medium is a compressible fluid. In the present embodiment, the circulation path is a closed path, and the working medium is a gas including, but not limited to, air, helium, argon, nitrogen, or carbon dioxide.

The hot end 1 and the cold end 2 are in thermal contact with the working medium during the circulation thereof along the circulation path. In the present embodiment, the hot end 1 is a high-temperature heat reservoir, and is heated by an external heat source (not shown) to maintain its temperature (e.g., 400° C.). The cold end is a low-temperature heat reservoir, and the temperature of the cold end 2 (e.g., room temperature) is lower than the temperature of the hot end 1.

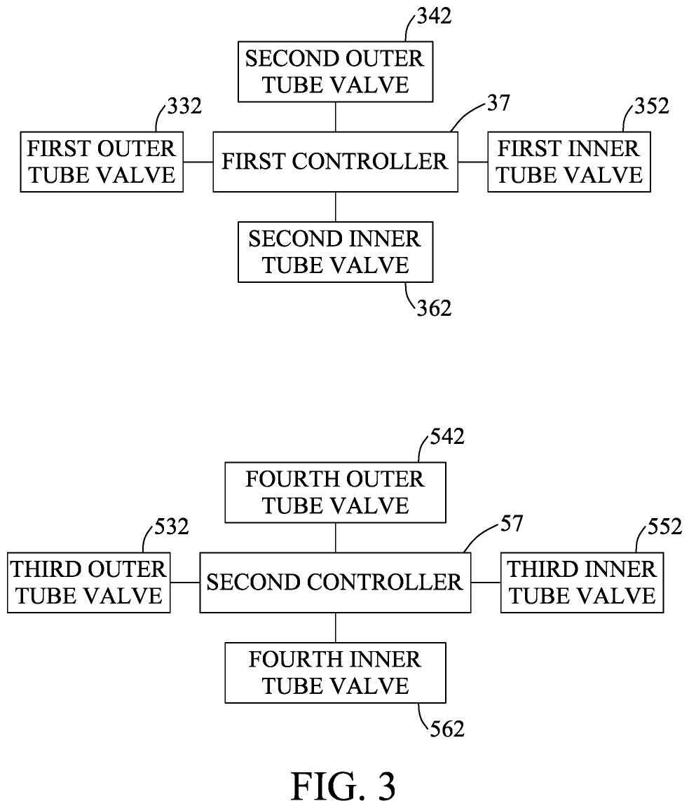

Referring to FIGS. 2 and 3, the first volume regulating unit 3 is disposed between the hot end 1 and cold end 2, and is configured to allow passage of the working medium therethrough to perform one of compression and expansion of the working medium during the circulation thereof.

The first volume regulation unit 3 includes a first cylinder 31, a first piston unit 32, a first outer tube 33, a second outer tube 34, a first inner tube 35, a second inner tube 36 and a first controller 37.

The first piston unit 32 is movably disposed in the first cylinder 31, and divides an inner space of the first cylinder 31 into a first outer chamber 311 and a first inner chamber 312. The first piston unit 32 extends through the first inner chamber 312 out of the first cylinder 31. Two of the first outer, second outer, first inner and second inner tubes 33, 34, 35, 36 communicate fluidly one of the first outer and first inner chambers 311, 312 with the hot and cold ends 1, 2, and the other two thereof communicate fluidly the other one of the first outer and first inner chambers 311, 312 with the hot and cold ends 1, 2. In this embodiment, the first and second outer tubes 33, 34 communicate fluidly the first inner chamber 311 with the hot and cold ends 1, 2, respectively, and the first and second inner tubes 35, 36 communicate fluidly the second inner chamber 312 with the hot and cold ends 1, 2, respectively.

Specifically, the first outer tube 33 includes a first outer tube body 331 and a first outer tube valve 332. The first outer tube body 331 intercommunicates fluidly the first outer chamber 311 with the hot end 1 to allow the working medium to flow therebetween. The first outer tube valve 332 is mounted to the first outer tube body 331 and is operable to open or close the first outer tube body 331.

The second outer tube 34 includes a second outer tube body 341 and a second outer tube valve 342. The second outer tube body 341 intercommunicates fluidly the first outer chamber 311 with the cold end 2 to allow the working medium to flow therebetween. The second outer tube valve 342 is mounted to the second outer tube body 341 and is operable to open or close the second outer tube body 341.

The first inner tube 35 includes a first inner tube body 351 and a first inner tube valve 352. The first inner tube body 351 intercommunicates fluidly the first inner chamber 312 with the hot end 1 to allow the working medium to flow therebetween. The first inner tube valve 352 is mounted to the first inner tube body 351 and is operable to open or close the first inner tube body 351.

The second inner tube 36 includes a second inner tube body 361 and a second inner tube valve 362. The second inner tube body 361 intercommunicates fluidly the first inner chamber 312 with the cold end 2 to allow the working medium to flow therebetween. The second inner tube valve 362 is mounted to the second inner tube body 361 and is operable to open or close the second inner tube body 361.

The first controller 37 is a programmable logic controller (PLC) in the present embodiment, and is operable to control the first outer, second outer, first inner and second inner tube valves 332, 342, 352, 362 so as to open or close the first outer, second outer, first inner and second inner tube bodies 331, 341, 351, 361.

The second volume regulating unit 5 is disposed between the hot end 1 and cold end 2, and is configured to allow passage of the working medium therethrough to perform the other one of compression and expansion of the working medium during the circulation thereof.

The second volume regulating unit 5 includes a second cylinder 51, a second piston unit 52, a third outer tube 53, a fourth outer tube 54, a third inner tube 55, a fourth inner tube 56 and a second controller 57.

The volume of the second cylinder 51 is greater than that of the first cylinder 31, and the cross sectional area of the second cylinder 51 is also greater than that of the first cylinder 31.

The second piston unit 52 is movably disposed in the second cylinder 51, and divides an inner space of the second cylinder 51 into a second outer chamber 511 and a second inner chamber 512. The second piston unit 52 extends through the second inner chamber 512 out of the second cylinder 51. Two of the third outer, fourth outer, third inner and fourth inner tubes 53, 54, 55, 56 communicate fluidly one of the second outer and second inner chambers 511, 512 with the hot and cold ends 1, 2, and the other two thereof communicate fluidly the other one of the second outer and second inner chambers 511, 512 with the hot and cold ends 1, 2. In this embodiment, the third and fourth outer tubes 53, 54 communicate fluidly the second outer chamber 511 with the hot and cold ends 1, 2, respectively, and the third and fourth inner tubes 55, 56 communicate fluidly the second inner chamber 512 with the hot and cold ends 1, 2, respectively.

Specifically, the third outer tube 53 includes a third outer tube body 531 and a third outer tube valve 532. The third outer tube body 531 intercommunicates fluidly the second outer chamber 511 with the hot end 1 to allow the working medium to flow therebetween. The third outer tube valve 532 is mounted to the third outer tube body 531 and is operable to open or close the third outer tube body 531.

The fourth outer tube 54 includes a fourth outer tube body 541 and a fourth outer tube valve 542. The fourth outer tube body 541 intercommunicates fluidly the second outer chamber 511 with the cold end 2 to allow the working medium to flow therebetween. The fourth outer tube valve 542 is mounted to the fourth outer tube body 541 and is operable to open or close the fourth outer tube body 541.

The third inner tube 55 includes a third inner tube body 551 and a third inner tube valve 552. The third inner tube body 551 intercommunicates fluidly the second inner chamber 512 with the hot end 1 to allow the working medium to flow therebetween. The third inner tube valve 552 is mounted to the third inner tube body 551 and is operable to open or close the third inner tube body 551.

The fourth inner tube 56 includes a fourth inner tube body 561 and a fourth inner tube valve 562. The fourth inner tube body 561 intercommunicates fluidly the second inner chamber 512 with the cold end 2 to allow the working medium to flow therebetween. The fourth inner tube valve 562 is mounted to the fourth inner tube body 561 and is operable to open or close the fourth inner tube body 561.

The second controller 57 is a programmable logic controller (PLC) in the present embodiment, and is operable to control the third outer, fourth outer, third inner and fourth inner tube valves 532, 542, 552, 562 so as to open or close the third outer, fourth outer, third inner and fourth inner tube bodies 531, 541, 551, 561.

It should be noted that, in other embodiments of the disclosure, the first outer, first inner, second outer, second inner, third outer, third inner, fourth outer and fourth inner tube valves 332, 352, 342, 362, 532, 552, 542, 562 may be configured as a valve train, and a connecting structure that interconnects the transmission unit 7 and the aforementioned tube valves 332, 352, 342, 362, 532, 552, 542, 562 may be configured as a substitute for the first and second controllers 37, 57 for opening and closing these tube valves 332, 352, 342, 362, 532, 552, 542, 562.

The transmission unit 7 is connected to the first and second volume regulating units 3, 5 for transferring kinetic energy to or from the first and second volume regulating units 3, 5. The transmission unit 7 includes a rotary shaft 71, a first link 72 and a second link 73. The first link 72 is movably connected between the rotary shaft 71 and the first piston unit 32, and the second link 73 is movably connected between the rotary shaft 71 and the second piston unit 52 such that rotation of the rotary shaft 71 drives the first and second links 72, 73 to move the first and second piston units 32, 52 relative to the first and second cylinders 31, 51.

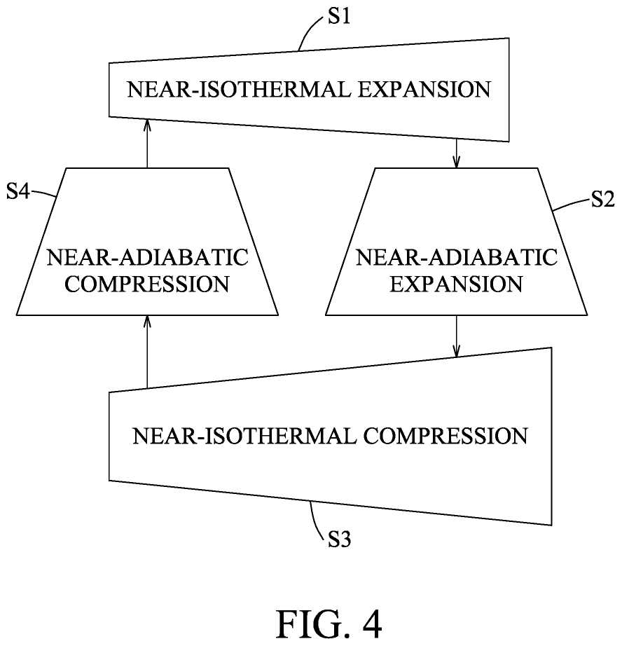

Referring to FIG. 4, an operating method for the mechanical device 100 approximating to the Carnot cycle includes the following steps: a near-isothermal expansion (S1), a near-adiabatic expansion (S2), a near-isothermal compression (S3) and a near-adiabatic compression (S4).

By conducting the aforementioned four steps, the working medium is driven to circulate along the circulation path. During a cycle of circulation, a volume of the working medium exiting the first volume regulating unit 3 differs from a volume of the working medium entering the second volume regulating unit 5, and a volume of the working medium entering the first volume regulating unit 3 differs from a volume of the working medium exiting the second volume regulating unit 5.

Specifically, referring to FIGS. 2, 3 and 4, during the step of near-isothermal expansion (S1), the first controller 37 of first volume regulating unit 3 is operated to open the first outer tube valve 332 and the second inner tube valve 362, and to close the second outer tube valve 342 and the first inner tube valve 352. At the same time, the second controller 57 of the second volume regulating unit 5 is operated to open the fourth outer tube valve 542 and the third inner tube valve 552, and to close the third outer tube valve 532 and the fourth inner tube valve 562.

By virtue of expansion of the working medium resulting from heat being transferred from the hot end 1, or movement of the first piston unit 32 in a first sliding direction (D1) resulting from the rotation of the rotary shaft 71 in a first rotational direction (R1), the working medium is driven to flow from the first outer chamber 311 of first volume regulating unit 3 into thermal contact with the hot end 1 via the first outer tube body 331, and from the cold end 2 into the first inner chamber 312 via the second inner tube body 361.

At the same time, the second piston unit 52 is driven to move in a second sliding direction (D2) opposite to the first sliding direction (D1), and the working medium is drawn from the hot end 1 into the second inner chamber 512 of the second volume regulating unit 5 via the third inner tube body 551, and from the second outer chamber 511 into thermal contact with the cold end 2 via the fourth outer tube body 541.

Since the cross sectional area of the first cylinder 31 is smaller than that of the second cylinder 51, and since the distances travelled by the first piston unit 32 and the second piston unit 52 during the rotation of the rotary shaft 71 are approximately the same, a first volume of the working medium moved from the first outer chamber 311 of the first volume regulating unit 3 into thermal contact with the hot end 1 is smaller than a second volume of the working medium moved from, the hot end 1 into the second inner chamber 512 of the second volume regulating unit 5. The overall volume of the working medium circulating in the first outer chamber 311, the first outer tube body 331, the second inner chamber 512 and the third inner tube body 551 expands to perform heat exchange between the working medium the hot end 1.

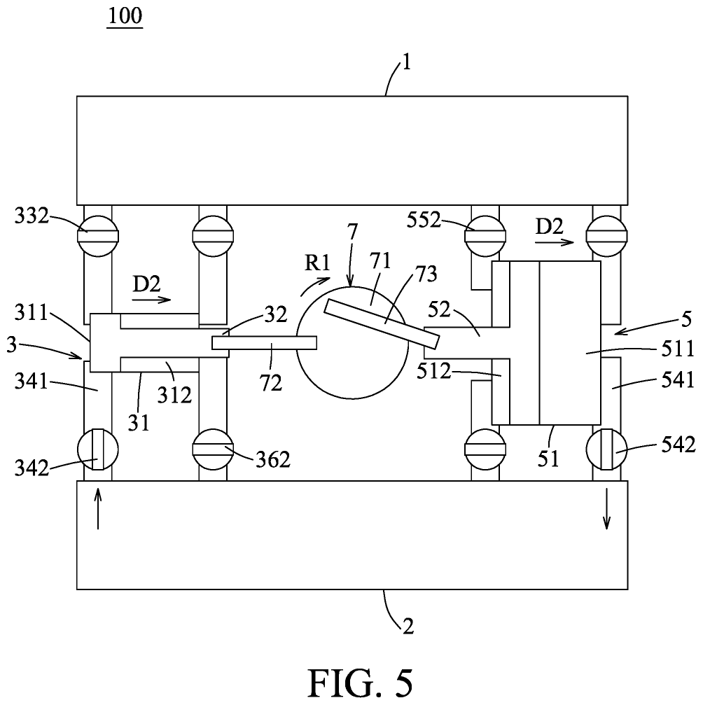

Referring to FIGS. 3, 4 and 5, during the step of near-adiabatic expansion (S2), the first controller 37 opens the second outer tube valve 342, and closes the first outer tube valve 332 and the second inner tube valve 362. The second controller 57 closes the third inner tube valve 552.

As the working medium expands in the second inner chamber 512 of the second volume regulating unit 5, the second piston unit 52 moves in the second sliding direction (D2), thereby driving and the rotary shaft 71 to keep rotating in the first rotational direction (R1) via the second link 73, and also driving the working medium to flow from the second outer chamber 511 to the cold end 2 via the fourth outer tube body 541.

At the same time, the first piston unit 32 is driven to move in the second sliding direction (D2), drawing the working medium from the cold end 2 into the first outer chamber 311 via the second outer tube body 341, and simultaneously compressing the working medium in the first inner chamber 312.

Since the working medium in the second inner chamber 512 is not in thermal contact with either of the hot and cold ends 1, 2, it expands in a nearly adiabatic environment and the temperature thereof drops to be approximately the same as that of the cold end 2.

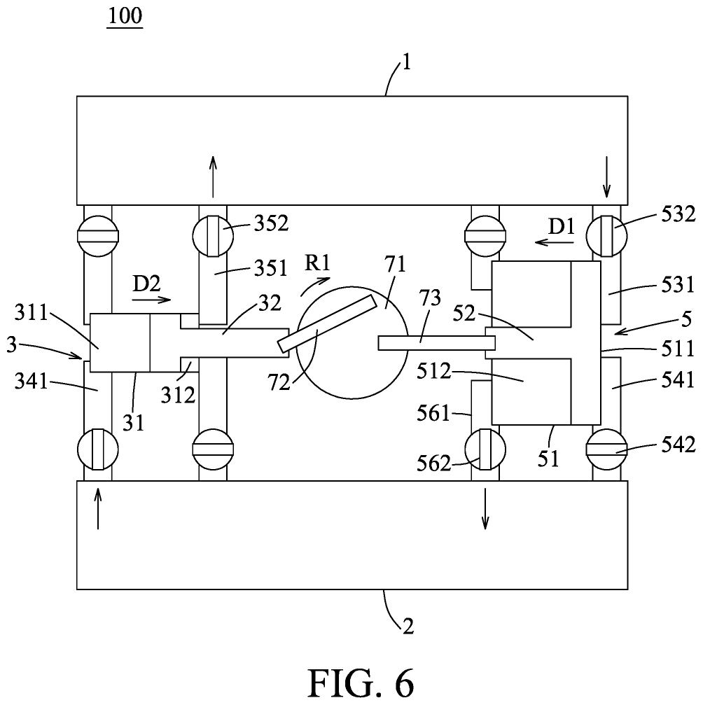

Referring to FIGS. 3, 4 and 6, during the step of near-isothermal compression (S3), the first controller 37 opens the first inner tube valve 352. The second controller 57 opens the third outer tube valve 532 and the fourth inner tube valve 562, and closes the fourth outer tube valve 542.

By virtue of rotational inertia of the rotary shaft 71, the rotary shaft 71 continues to rotate in the first rotational direction (R1), and the first piston unit 32 continues to move in the second sliding direction (D2), drawing the working medium from the cold end 2 into the first outer chamber 311 via the second outer tube body 341. At the same time, the second piston unit 52 is driven by the second link 73 to move in the first sliding direction (D1), and the working medium is driven to flow from the second inner chamber 512 into thermal contact with the cold end 1 via the fourth inner tube body 561, and from the hot end 1 into the second outer chamber 511 via the third outer tube body 531.

Since, as mentioned above, the transverse cross sectional area of the first cylinder 31 is smaller than that of the second cylinder 51, and since the distances travelled by the first piston unit 32 and the second piston unit 52 during the rotation of the rotary shaft 71 are approximately the same, a third volume of the working medium moved from the second inner chamber 512 of the second volume regulating unit 5 into the cold end 2 is greater than a fourth volume of the working medium moved from the cold end 2 into the first outer chamber 311 of the first volume regulating unit 3. The overall volume of the working medium circulating in the second inner chamber 512, the fourth inner tube body 561, the cold end 2, the second outer tube body 341 and the first outer chamber 311 is compressed to perform heat exchange between the working medium and the cold end 2.

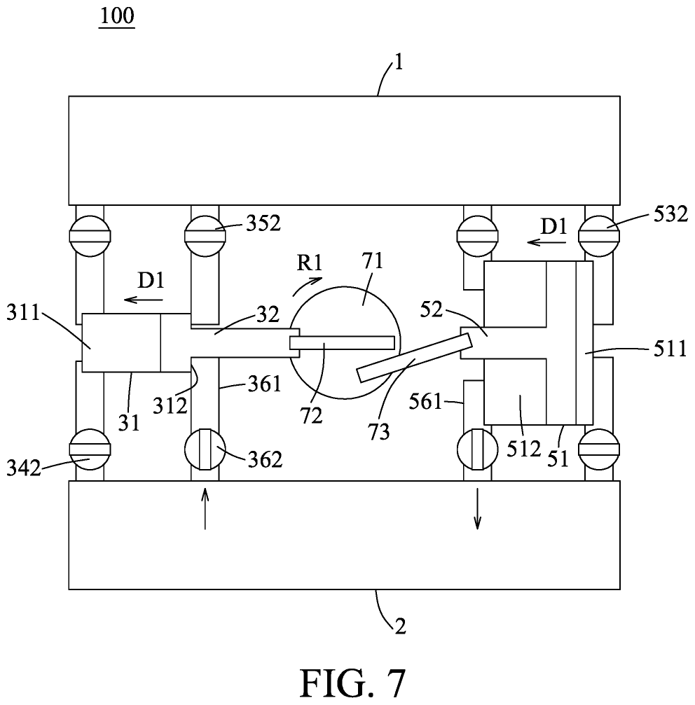

Referring to FIGS. 3, 4 and 7, during the step of near-adiabatic compression (S4), the first controller 37 opens the second inner tube valve 362, and closes the second outer tube valve 342 and the first inner tube valve 352. The second controller 57 closes the third outer tube valve 532.

The working medium continues to move the second piston unit 52 in the first sliding direction (D1), thereby driving and the rotary shaft 71 to keep rotating in the first rotational direction (R1) via the second link 73, and also driving the working medium to flow from the second inner chamber 512 into thermal contact with the cold end 2 via the fourth inner tube body 561. At the same time, the first piston unit 32 is driven to move in the first sliding direction (D1), drawing the working medium from the cold end 2 into the first inner chamber 312 via the second inner tube body 361, and simultaneously compressing the working medium in the first outer chamber 311.

Since the working medium in the first outer chamber 311 is not in thermal contact with either of the hot and cold ends 1, 2, it is compressed in a nearly adiabatic environment and the temperature thereof rises to be approximately the same as that of the hot end 1.

When the step of near-adiabatic compression (S4) ends, a cycle of the operation is completed. After that, the operating method for the mechanical device 100 may be repeated in the order described above.

By virtue of configurations of the first and second volume regulating units 3, 5 and the transmission unit 7, the volume of the working medium exiting or entering the first volume regulating unit 3 is smaller than the volume entering or exiting the second volume regulating unit 5 (i.e., the first volume is smaller than the second volume, and the fourth volume is smaller than the third volume), and the the working medium is allowed to expand and be compressed in a nearly adiabatic environment. In addition, it should be noted that the temperature of the working medium exiting the first volume regulating unit 3 is higher than the temperature of the working medium exiting the second volume regulating unit 5.

When the mechanical device 100 is operated in the abovementioned manner, the operation approximates to a Carnot cycle and the mechanical device 100 performs as a heat engine, which can be used as a power source for outputting kinetic energy to external component. For example, when the mechanical device 100 is used with a generator, the rotary shaft 71 is connected to an external component such as a rotor, which can be driven to rotate relative to a stator, thereby generating electricity; and when the mechanical device 100 is used with a vehicle, the rotary shaft 71 is connected to an external component such as a wheel for driving the wheel to rotate.

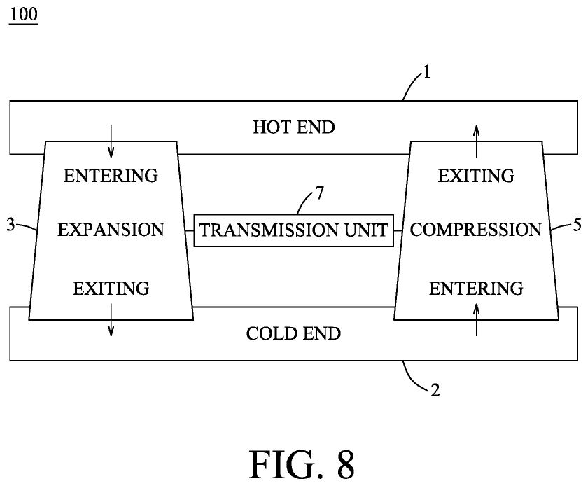

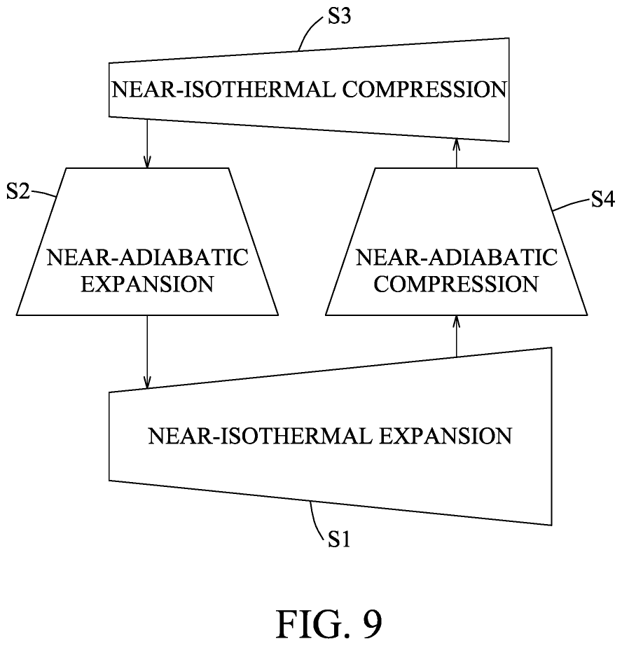

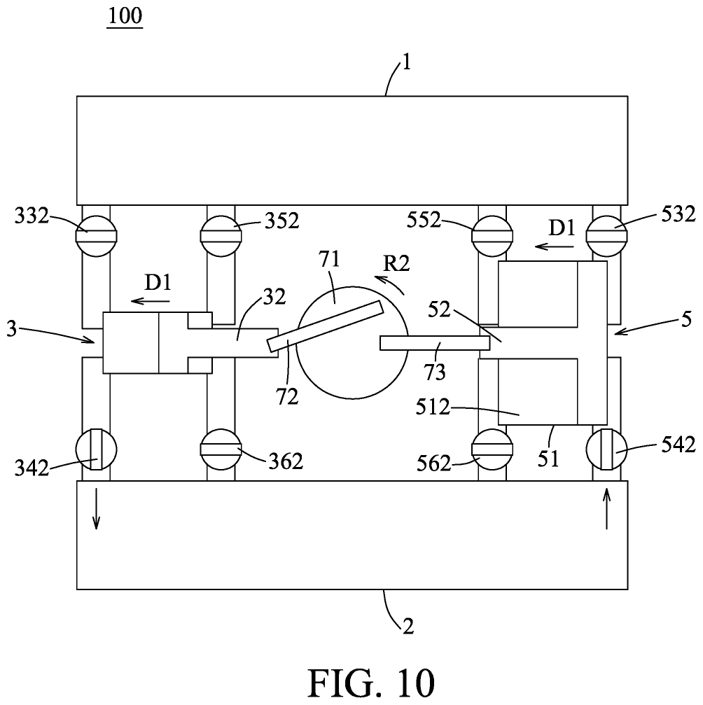

Referring to FIGS. 8 and 9, the mechanical device 100 may also be operated in a reversed manner such that the operation approximates to a reverse Carnot cycle. In this case, the mechanical device 100 performs as a heat pump, in which the hot end 1 releases heat to the external environment and the cold end 2 absorbs heat from the external environment, and in which the rotary shaft 71 (see FIG. 10) is connected to an external power source such as a motor to be driven thereby. The schematic diagram shown in FIG. 9 illustrates the mechanical device 100 being operated in such reversed manner, and an operating method thereof that approximates to the reverse Carnot cycle includes the following steps: a near-adiabatic compression (S4), a near-isothermal compression (S3), a near-adiabatic expansion (S2), and a near-isothermal expansion (S1).

Referring to FIGS. 3, 9 and 10, during the step of near-adiabatic compression (S4), the first controller 37 of first volume regulating unit 3 is operated to open the second outer tube valve 342, and to close the first outer tube valve 332, the first inner tube valve 352, and the second inner tube valve 362. At the same time, the second controller 57 of the second volume regulating unit 5 is operated to open the fourth outer tube valve 542, and to close the third outer tube valve 532, the third inner tube valve 552, and the fourth inner tube valve 562, and the rotary shaft 71 is driven by an external power source to rotate in the second rotational direction (R2).

During the rotation of the rotary shaft 71, the second link 73 drives the second piston unit 52 to move in the first sliding direction (D1) such that the second piston unit 52 compresses the working medium in the second inner chamber 512 of the second volume regulating unit 5, and the temperature of the working medium in the second inner chamber 512 rises to be approximately the same as that of the hot end 1. At the same time, the rotary shaft 71 drives the first piston unit 32 to move in the first sliding direction (D1) via the first link 72.

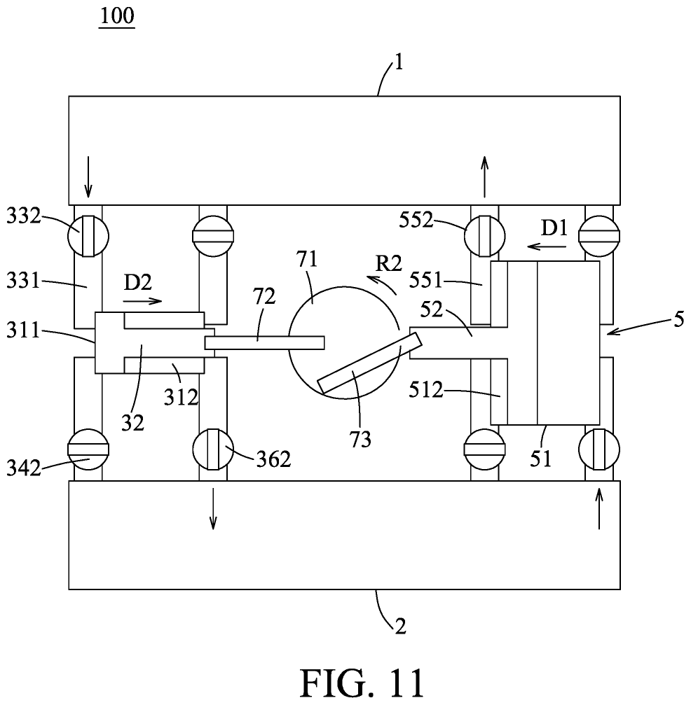

Referring to FIGS. 3, 9 and 11, during the step of near-isothermal compression (S3), the first controller 37 opens the first outer tube valve 332 and the second inner tube valve 362, and closes the second outer tube valve 342, and the second controller 57 opens the third inner tube valve 552.

At this time, the second piston unit 52 moves in the first sliding direction (D1). A first volume of the working medium is driven by the second piston unit 52 to flow from the second inner chamber 512 of the second volume regulating unit 5 into thermal contact with the hot end 1 via the third inner tube body 551, and a second volume of the working medium is drawn from the hot end 1 into the first outer chamber 311 via the first outer tube body 331. The first volume of the working medium is greater than the second volume so that the working medium is compressed during thermal contact with the hot end 1 and performs heat exchange therewith. During this process, the temperature of the working medium remains approximately the same as the hot end 1.

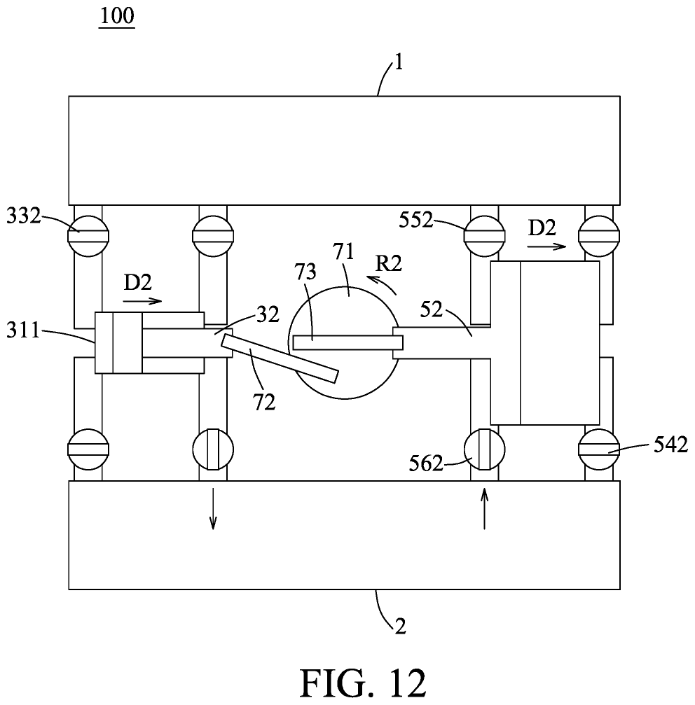

Referring to FIGS. 3, 9 and 12, during the step of near-adiabatic expansion (S2), the first controller 37 closes the first outer tube valve 332, and the second controller 57 opens the fourth inner tube valve 562, and closes the fourth outer tube valve 542 and the third inner tube valve 552.

At this time, the first volume regulating unit 3 is operated such that the working medium in the first outer chamber 311 expands and the temperature thereof drops to be approximately the same as that of the cold end 2.

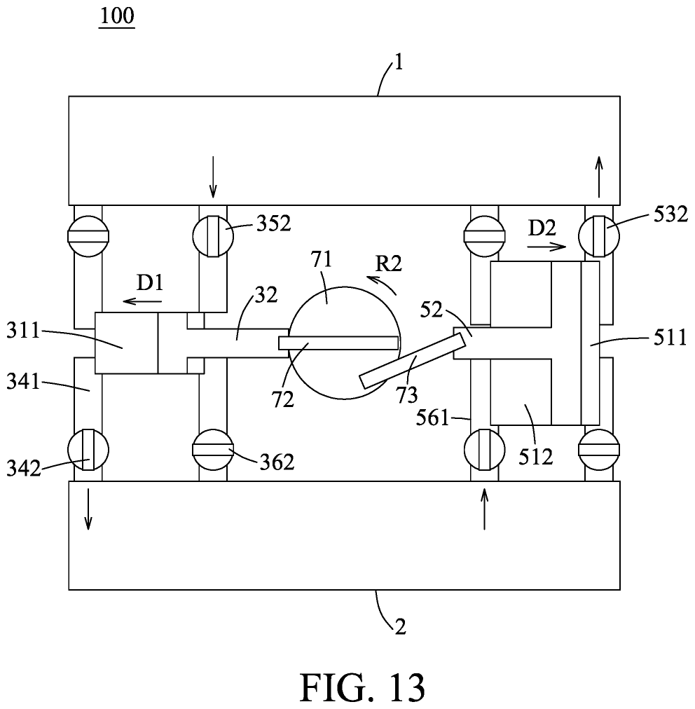

Referring to FIGS. 3, 9 and 13, during the step of near-isothermal expansion (S1), the first controller 37 opens the second outer tube valve 342 and the first inner tube valve 352, and closes the second inner tube valve 362, and the second controller 57 opens the third outer tube valve 532.

At this time, the first piston unit 32 moves in the first moving direction (D1). A third volume of the working medium is driven by the first piston unit 32 to flow from the first outer chamber 311 into thermal contact with the cold end 2 via the second outer tube body 341, and a fourth volume of the working medium is drawn from the cold end 2 into the second inner chamber 512 via the fourth inner tube body 561. The third volume of the working medium is smaller than the fourth volume so that the working medium expands during thermal contact with the cold end 2 and performs heat exchange therewith. During this process, the temperature of the working medium remains approximately the same as the cold end 2.

When the step of near-isothermal expansion (S1) ends, a cycle approximating to the reverse Carnot cycle is completed, and such operating method may be repeated in the order described above.

Similar to the previous operating method that approximates to the normal Carnot cycle, during the operation in this case, the volume of the working medium entering or exiting the first volume regulating unit 3 is smaller than the volume exiting or entering the second volume regulating unit 5 (i.e., the second volume is smaller than the first volume, and the third volume is smaller than the fourth volume), and the working medium is allowed to be compressed and expand in a nearly adiabatic environment. In addition, it should be noted that the temperature of the working medium exiting the first volume regulating unit 3 is lower than the temperature of the working medium exiting the second volume regulating unit 5.

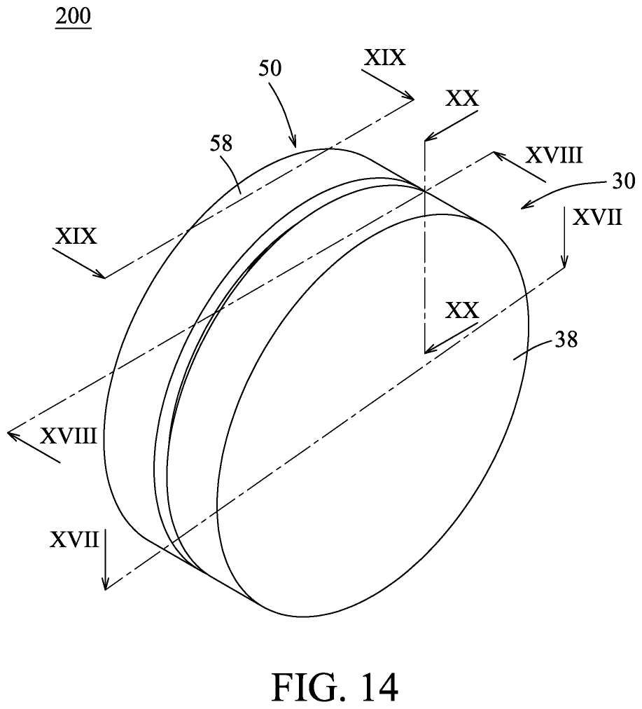

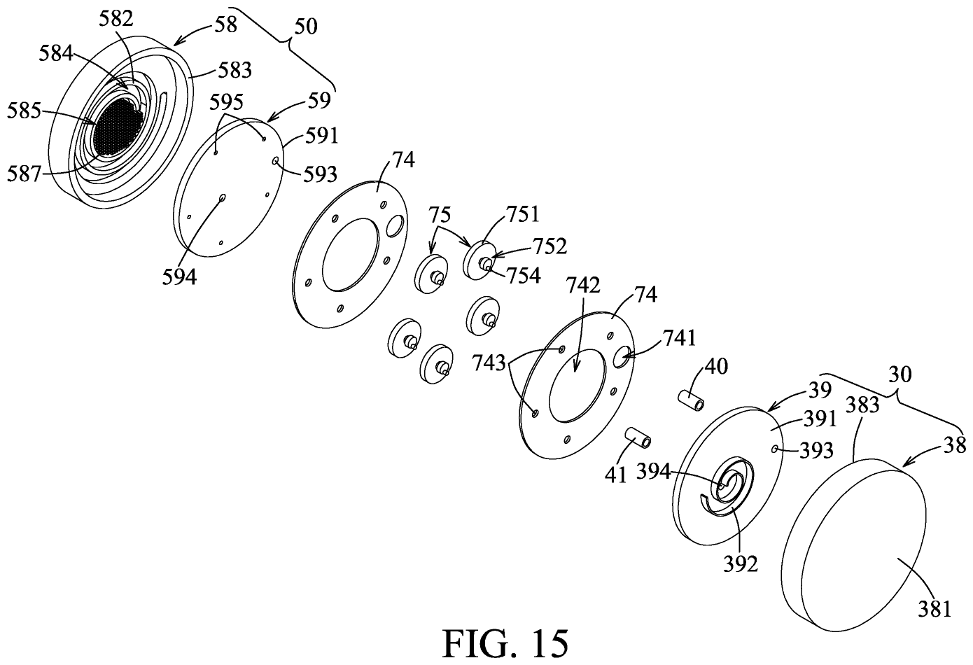

Referring to FIGS. 14 and 15, a second embodiment of the mechanical device 200 according to the disclosure performs similar functions as does the first embodiment. However, in the second embodiment, the mechanical device 200 includes a first complex unit 30 and a second complex unit 50.

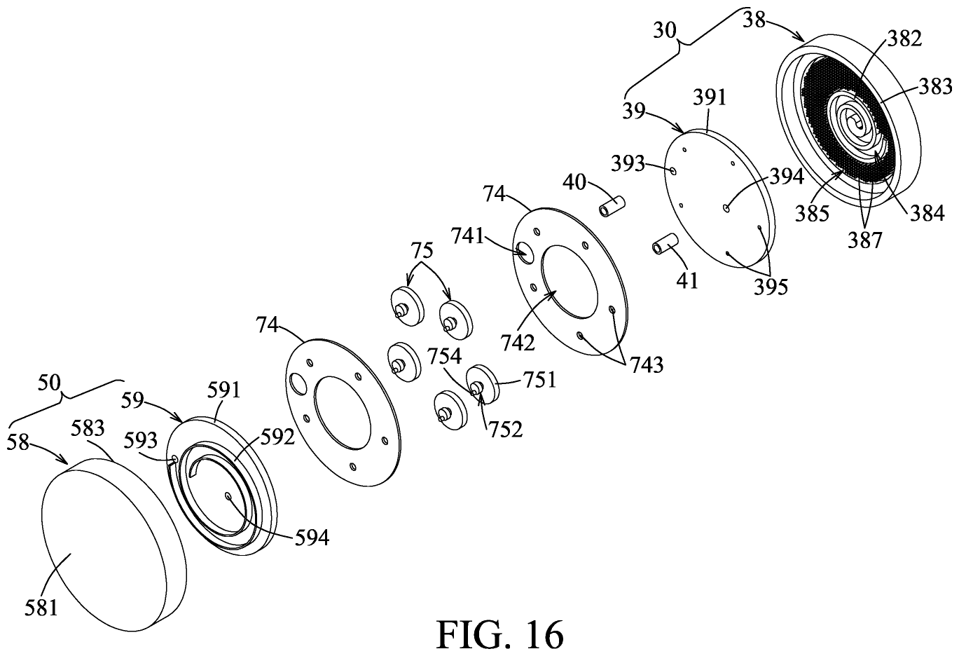

Referring to FIGS. 16, 17 and 18, the first complex unit 30 includes a first end cap 38 and a first movable disc 39. The first end cap 38 is adapted to be fixed to an external component (not shown) so as to remain stationary during operation, and includes a first end wall 381, a first stationary scroll 382 and a first surrounding wall 383.

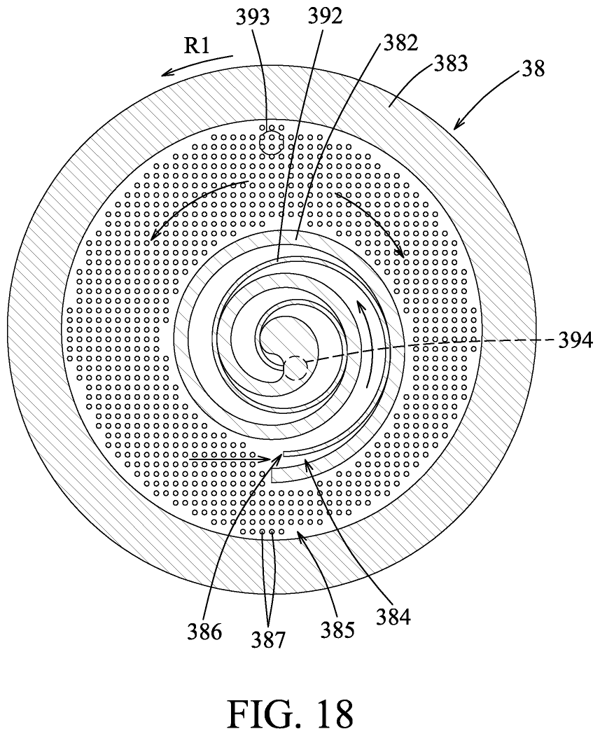

The first end wall 381 constitutes the cold end. The first stationary scroll 382 is fixed on the first end wall 381 and cooperates with the first end wall 381 to define the first volume regulating unit 384 for the working medium to flow therethrough. The first surrounding wall 383 extends from an outer periphery of the first end wall 381, and surrounds and is spaced apart from the first stationary scroll 382. The first end wall 381, the first stationary scroll 382 and the first surrounding wall 383 cooperatively define a first heat exchange chamber 385 that surrounds the first volume regulating unit 384. The first volume regulating unit 384 has a first connecting section 386 (see FIG. 18). The first volume regulating unit 384 and the first heat exchange chamber 385 are in spatial communication via the first connecting section 386.

The first end cap 38 further includes a plurality of first heat dissipating components 387 that are configured as cylindrical pins disposed in the first heat exchange chamber 385 and connected to the first end wall 381. Disposition of the first heat dissipating components 387 increases a total area of contact between the working medium and the first end cap 38, so as to promote efficiency of heat transfer therebetween. In variations of the embodiment, the first heat dissipating components 387 may also be, but not limited to, fin-shaped.

Referring to FIGS. 15, 16 and 17, the first movable disc 39 is movably engaged with the first end cap 38, and includes a first disc body 391 and a first movable scroll 392. The first movable scroll 392 is received in the first volume regulating unit 384, and is movable relative to the first stationary scroll 382. The first disc body 391 is connected to the first movable scroll 392 such that the first movable scroll 392 is disposed between the first disc body 391 and the first end wall 381, and is surround by the first surrounding wall 383.

The first disc body 391 is formed with a first through hole 393, a second through hole 394 and a plurality of first connecting holes 395. The first through hole 393 is located proximate to a periphery of the first disc body 391 and is in spatial communication with the first heat exchange chamber 385. The second through hole 394 is located proximate to the center of the first disc body 391, is surrounded by the first movable scroll 392, and is in spatial communication with the first volume regulating unit 384.

The first connecting holes 395 are spaced-apart blind holes located on a side of the first disc body 391 opposite to the first movable scroll 392, and are also proximate to the periphery of the first disc body 391. By virtue of movement of the first movable scroll 392 relative to the first stationary scroll 382, the working medium flowing therebetween can expand or be compressed.

Referring to FIGS. 15, 16, 17 and 19, the second complex unit 50 includes a second end cap 58 and a second movable disc 59. The second end cap 58 is adapted to be fixed to an external component (not shown) so as to remain stationary during operation, and includes a second end wall 581, a second stationary scroll 582 and a second surrounding wall 583.

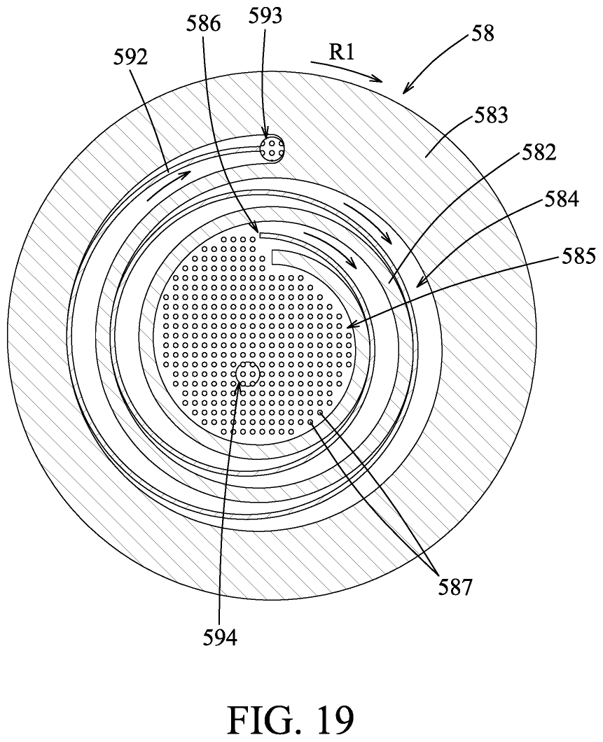

The second end wall 581 constitutes the hot end. The second stationary scroll 582 is fixed on the second end wall 581 and cooperates with the second end wall 581 to define the second heat exchange chamber 585 for the working medium to flow therethrough. It should be noted that the capacity of the first volume regulating unit 384 is smaller than that of the second volume regulating unit 584. The second surrounding wall 583 extends from an outer periphery of the second end wall 581, surrounds the second stationary scroll 582, and is connected to an outer periphery of the second stationary scroll 582. The second end wall 581, the second stationary scroll 582 and the second surrounding wall 583 cooperatively define a second volume regulating unit 584 that surrounds the second heat exchange chamber 585. The second volume regulating unit 584 has a second connecting section 586 (see FIG. 19). The second volume regulating unit 584 and the second heat exchange chamber 585 are in spatial communication via the second connecting section 586.

The second end cap 58 further includes a plurality of second heat dissipating components 587 that are configured as cylindrical pins disposed in the second heat exchange chamber 585, surrounded by the second stationary scroll 582, and connected to the second end wall 581. Similar to the first heat dissipating components 387, the second heat dissipating components 587 increase a total area of contact between the working medium and the second end cap 58, so as to promote efficiency of heat transfer therebetween. In variations of the embodiment, the second heat dissipating components 587 may also be, but not limited to, fin-shaped.

Referring to FIGS. 15, 16 and 17, the second movable disc 59 is movably engaged with the second end cap 58, and includes a second disc body 591 and a second movable scroll 592. The second movable scroll 592 is received in the second volume regulating unit 584, and is movable relative to the second stationary scroll 582. The second disc body 591 is connected to the second movable scroll 592 such that the second movable scroll 592 is disposed between the second disc body 591 and the second end wall 581, and is surround by the second surrounding wall 583.

The second disc body 591 is formed with a first through hole 593, a second through hole 594 and a plurality of second connecting holes 595. The first through hole 593 is located proximate to a periphery of the second disc body 591 and is in spatial communication with the second volume regulating unit 584. The second through hole 594 is located proximate to the center of the second disc body 591, is surrounded by the second movable scroll 592, and is in spatial communication with the second heat exchange chamber 585. The second connecting holes 595 are spaced-apart blind holes located on a side of the second disc body 591 opposite to the second movable scroll 592, and are also proximate to the periphery of the second disc body 591.

By virtue of movement of the second movable scroll 592 relative to the second stationary scroll 582, the working medium flowing therebetween can expand or be compressed.

The present embodiment further includes a first connecting tube 40 and a second connecting tube 41, each of which connects the first movable disc 39 with the second movable disc 59 such that movements of the first and second movable discs 39, 59 are synchronized.

Specifically, the first connecting tube 40 has opposite ends registered respectively with the first through holes 393, 593 of the first and second disc bodies 391, 591, and is welded between the first and second disc bodies 391, 591, such that the first connecting tube 40 and the first and second disc bodies 391, 591 cooperatively define a first passage 401. Similarly, the second connecting tube 41 has opposite ends registered respectively with the second through holes 394, 594 of the first and second disc bodies 391, 591, and is welded between the first and second disc bodies 391, 591, such that the second connecting tube and the first and second disc bodies 391, 591 cooperatively define a second passage 411.

Referring to FIGS. 15, 16, 17 and 20, the transmission unit 7 of the present embodiment is connected to the first and second movable discs 39, 59 for transferring kinetic energy to or from the first and second movable discs 39, 59 (i.e., either one of the first and second movable discs 39, 59 may drive or be driven by the transmission unit 7 to move since movements of the first and second movable discs 39 are synchronized).

Specifically, the transmission unit 7 includes two carrier discs 74 and a plurality of transmitting components 75. The carrier discs 74 are disposed between the first and second movable discs 39, 59. One of the carrier discs 74 is surrounded by and press fitted within the first surrounding wall 383 of the first end cap 38, and the other one of the carrier discs 74 is surrounded by and press fitted within the second surrounding wall 583 of the second end cap 58 such that both carrier discs 74 remain stationary during operation.

Each of the carrier discs 74 is formed with a first opening 741, a second opening 742 and a plurality of shaft holes 743. The first and second connecting tubes 40, 41 extend respectively through the first and second openings 741, 742 of each of the carrier discs 74. For each of the carrier discs 74, the first opening 741 is located proximate to a periphery thereof, and has a diameter greater than the outer diameter of the first connecting tube 40 such that the first connecting tube 40 is allowed to move therein; the second opening 742 is located proximate to the center thereof, and has a diameter greater than the outer diameter of the second connecting tube 41 such that the second connecting tube 41 is allowed to move therein; and the shaft holes 743 are spaced apart from each other and are arranged around the second opening 742.

Each of the transmitting components 75 has a wheel body 751 and two shaft bodies 752. The wheel body 751 of each of the transmitting components 75 is disposed between the carrier discs 74, and is adapted to be connected to an external structure (not shown) for transferring kinetic energy. For example, in variations of the embodiment, the wheel body 751 may be provided with an external thread to engage an internal thread of the external structure, or configured as a pulley (or sprocket) to be engaged with a belt (or chain).

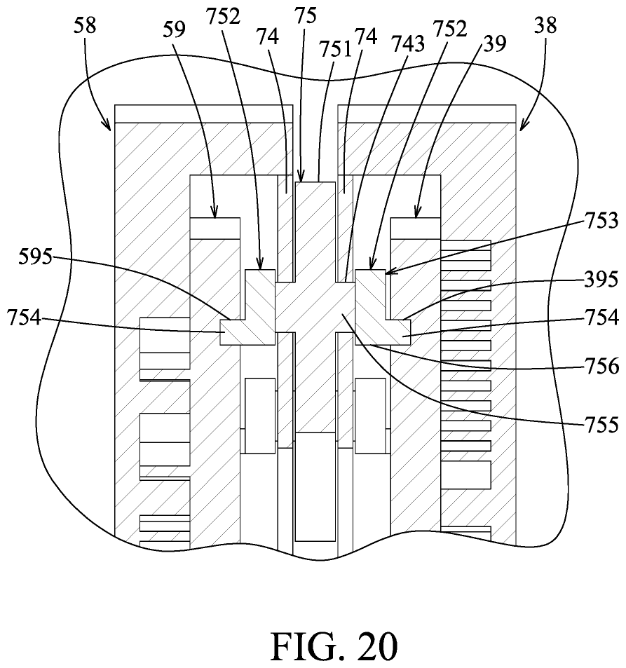

The shaft bodies 752 of each of the transmitting components 75 are connected respectively to opposite sides of the wheel body 751, extend respectively and rotatably through the carriers discs 74, are engaged respectively with the first and second movable discs 39, 59, and each have a main portion 753 (see FIG. 20) and an eccentric portion 754.

Referring specifically to FIG. 20, for each of the transmitting components 75, the main portion 753 of each of the shaft bodies 752 has a small segment 755 and a large segment 756; the small segment 755 is welded between the wheel body 751 and the large segment 756, and is received rotatably in a corresponding one the shaft holes 743 of the respective one of the carrier discs 74; the large segment 756 has a diameter greater than a diameter of the small segment 755 and a diameter of the corresponding shaft hole 743; and the eccentric portion 754 is connected to a side of the large segment 756 of the main portion 753 opposite to the small segment 756, and is axially misaligned with the main portion 753.

The eccentric portion 754 of one of the shaft bodies 752 of each of the transmitting components 75 is received rotatably in a corresponding one of the first connecting holes 395 of the first movable disc 39, and the eccentric portion 754 of the other one of the shaft bodies 752 is received rotatably in a corresponding one of the second connecting holes 595 of the second movable disc 59.

It should be noted that by virtue of the diameter of the large segment 756 of each shaft body 752 being greater than the diameter of the corresponding shaft hole 743, the carrier discs 74 are confined between the large segments 756 of the shaft bodies 752 and the wheel body 751 of each of transmitting components 75.

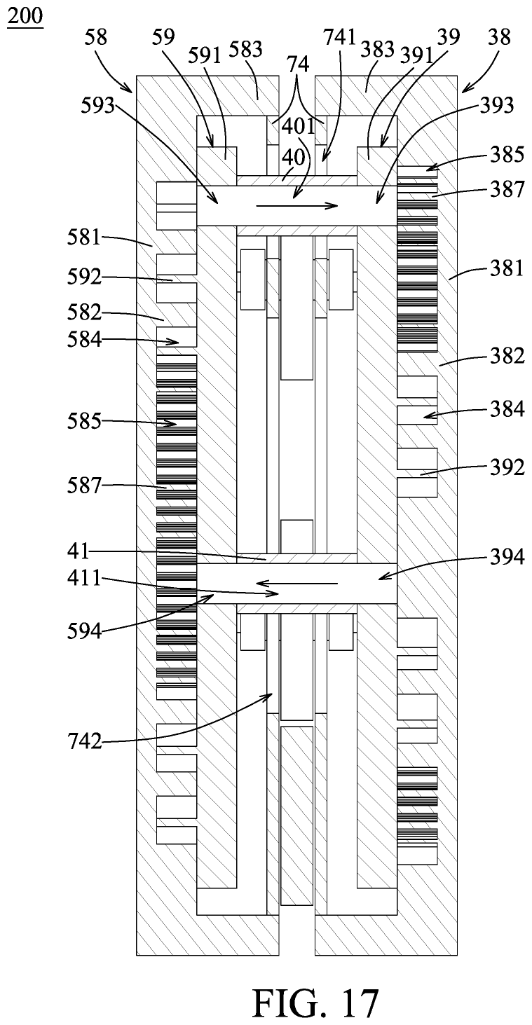

Referring to FIGS. 17, 18 and 19, when the mechanical device 200 is operated on a cycle approximating to the Carnot cycle, during the step of near-isothermal expansion (S1), by virtue of expansion of the working medium in the second heat exchange chamber 585, or rotational inertia of the transmitting components 75 or an external power source (not shown), the first and second movable discs 39, 59 are driven to move simultaneously relative to the first and second end caps 38, 58. At the same time, movement of the first movable scroll 392 relative to the first stationary scroll 382 drives the working medium in the first volume regulating unit 384 to flow into the second heat exchange chamber 585 via the second passage 411 of the second connecting tube 41, and as the working medium in the second heat exchange chamber 585 absorbs heat from the second end wall 581 of the second end cap 58 (i.e., the hot end), it expands and flows into the second volume regulating unit 584 via the second connecting section 586. During this process, the working medium in the second heat exchange chamber 585 expands and the temperature thereof remains approximately the same as the hot end 1, and the volume of the working medium moved from the first volume regulating unit 384 to the second heat exchange chamber 585 is smaller than the volume moved from the second heat exchange chamber 585 to the second volume regulating unit 584.

During the step of near-adiabatic expansion (S2), the working medium expands in the second volume regulating unit 584 and outputs kinetic energy such that the second movable scroll 592 is driven to move relative to the second stationary scroll 582. During this process, the volume of a space defined between the second stationary and second movable scrolls 591, 592 in the second volume regulating unit 584 varies, allowing the working medium to continue to expand and flow through the first passage 401 of the first connecting tube 40. The temperature of the working medium in the second volume regulating unit 584 drops to be approximately the same as that of the first end wall 381 of first end cap 38 (i.e., the cold end). In addition, movement of the second movable scroll 592 relative to the second stationary scroll 591 also drives the synchronized movements of the first and second movable discs 39, 59, as mentioned above, via the transmission unit 7.

Referring to FIGS. 17, 18 and 19, during the step of near-isothermal compression (S3), the working medium flows into the first heat exchange chamber 385 via the first passage 401, performs heat exchange with the first end wall 381 (i.e., the cold end), and flows into the first volume regulating unit 384 via the first connection section 386. During this process, the working medium in the first heat exchange chamber 385 is compressed and the temperature thereof remains approximately the same as the cold end, and the volume of the working medium moved from the second volume regulating unit 584 to the first heat exchange chamber 385 is greater than the volume moved from the first heat exchange chamber 385 to the first volume regulating unit 384.

In the step of near-adiabatic compression (S4), during the moving process of the first movable scroll 392 relative to the first stationary scroll 391, the volume of a space defined between the first stationary and first movable scrolls 391, 392 in the first volume regulating unit 384 varies such that the working medium continues to be compressed and flows through the second passage 411 into the second heat exchange chamber 585. At the same time, the temperature of the working medium in the first volume regulating unit 384 rises to be approximately the same as that of the second end wall 581 (i.e., the hot end). At this point, a cycle of the operation is completed and may be repeated in the order described above.

Referring to FIGS. 15 and 16, similar to the previous embodiment, the mechanical device 200 of the second embodiment may also be operated in a reversed manner such that the operation approximates to the reverse Carnot cycle. In this case, the second end cap 58 releases heat to the external environment and the first end cap 38 absorbs heat from the external environment.

The transmission unit 7 is connected to an external power source such that the wheel body 751 of each of the transmitting components 75 is driven thereby to rotate.

Referring to FIGS. 15 and 16, during the step of near-adiabatic compression (S4), each of the transmitting components 75 is driven by the external power source to rotate, thereby driving the synchronized movements of the first and second movable discs 39, 59. In virtue of the movement of the second movable scroll 592 relative to the second stationary scroll 591, the working medium in the second volume regulating unit 584 is compressed and the temperature thereof rises to be approximately the same as that of the second end wall 581 (i.e., the hot end).

During the step of near-isothermal compression (S3), the working medium flows from the second volume regulating unit 584 into the second heat exchange chamber 585 via the second connecting section 586, performs heat exchange with the second end wall 581 (i.e., the hot end), and flows into the first volume regulating unit 384 via the second passage 411.

Referring to FIGS. 15 and 16, during the step of near-adiabatic expansion (S2), by virtue of the movement of the first movable scroll 392 relative to the first stationary scroll 391, the working medium in the first volume regulating unit 384 expands and the temperature thereof drops to be approximately the same as that of the first end wall 381 (i.e., the cold end).

During the step of near-isothermal expansion (S1), the working medium flows from the first volume regulating unit 384 into the first heat exchange chamber 385 via the first connecting section 386, performs heat exchange with the first end wall 381 (i.e., the cold end), and flows into the second volume regulating unit 584 via the first passage 401. A cycle of the operation is now completed and may be repeated in the same order as described.

Similar to the previous embodiment, during a cycle of the operation, the volume of the working medium moved from the second volume regulating unit 584 into the first heat exchange chamber 385 differs from the volume moved from the first heat exchange chamber 385 into the first volume regulating unit 384, and the volume moved from the first volume regulating unit 384 into the second heat exchange chamber 585 differs from the volume moved from the second heat exchange chamber 585 into the second volume regulating unit 584. In such a manner, the working medium is allowed to expand and be compressed while the temperature thereof remains approximately constant.

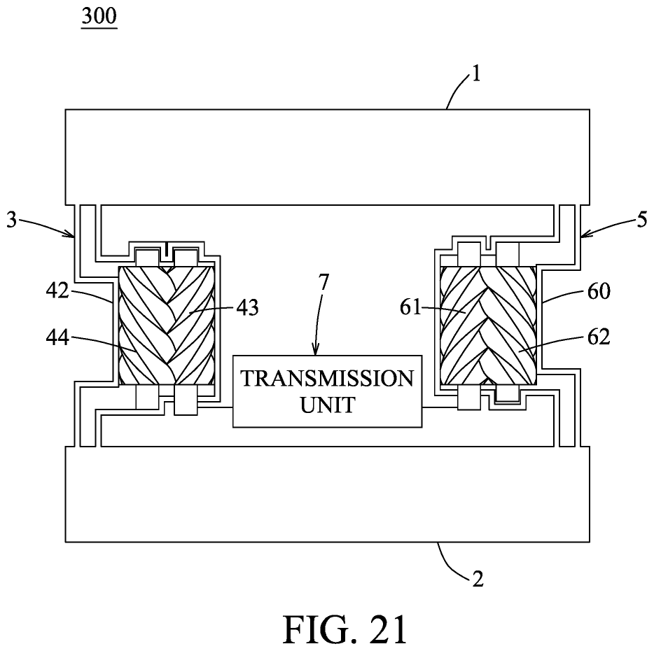

Referring to FIG. 21, a third embodiment of the mechanical device 300 according to the disclosure is similar to the first embodiment. The difference between the two resides in that, in the third embodiment, each of the first and second volume regulating units 3, 5 includes two intermeshed screws. However, in other embodiments, either one of the first and second volume regulating units 3, 5 may include a single screw or other structure that provides the equivalent functions.

Specifically, in the present embodiment, the first volume regulating unit 3 includes a first casing 42, a first driving rotor 43 and a first driven rotor 44. The first casing 42 is in spatial communication with the hot end 1 and the cold end 2 for allowing the working medium to flow therebetween. The first active and first driven rotors 43, 44 are disposed in and rotatably connected to the first casing 42, and are configured as two meshing screws, such that rotations thereof allow the working medium flowing therebetween to expand or be compress thereby.

Similarly, the second volume regulating unit 5 includes a second casing 60, a second driving rotor 61 and a second driven rotor 62. The second casing 60 is in spatial communication with the hot end 1 and the cold end 2 for allowing the working medium to flow therebetween. The second active and second driven rotors 61, 62 are disposed in and rotatably connected to the second casing 60, and are also configured as two intermeshed screws, such that rotations thereof allow the working medium flowing therebetween to expand or be compressed thereby.

The transmission unit 7 is connected between the first driving rotor 43 and the second driving rotor 61 for transferring kinetic energy thereto or therefrom.

When the mechanical device 300 is operated on a cycle approximating to the Carnot cycle, the volume of the working medium exiting the first volume regulating unit 3 is smaller than the volume entering the second volume regulating unit 5, and the volume of the working medium entering the first volume regulating unit 3 is also smaller than the volume exiting the second volume regulating unit 5.

Conversely, when the mechanical device 300 is operated on a cycle approximating to the reversed Carnot cycle, the volume of the working medium exiting the first volume regulating unit 3 is greater than the volume entering the second volume regulating unit 5, and the volume of the working medium entering the first volume regulating unit 3 is also greater than the volume exiting the second volume regulating unit 5.

It should be noted that, in other embodiments of the disclosure, the transmission unit 7 may be configured in a manner that the first and second volume regulating units 3, 5 operate at difference rotational speeds so as to result in different volumes of the working medium entering or exiting the first and second volume regulating units 3, 5.

In sum, for each of the embodiments of the mechanical device 100, 200, 300 according to the disclosure, during a single operation cycle, by virtue of the volume of the working medium exiting or entering the first volume regulating unit 3 being different from the volume entering or exiting the second volume regulating unit 5, the working medium is allowed to expand or be compressed in a manner that the operation approximates to the Carnot cycle or the reversed Carnot cycle. In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A mechanical device, comprising:
a working medium that is configured to circulate along a circulation path;
a hot end that is in thermal contact with said working medium during the circulation thereof;
a cold end that is in thermal contact with said working medium during the circulation thereof, a temperature of said cold end being lower than a temperature of said hot end;
a first volume regulating unit that is disposed between said hot and cold ends, and that is configured to allow passage of said working medium therethrough to perform one of compression and expansion of said working medium during the circulation thereof; and
a second volume regulating unit that is disposed between said hot and cold ends, and that is configured to allow passage of said working medium therethrough to perform the other one of compression and expansion of said working medium during the circulation thereof;
wherein during a cycle of circulation of said working medium, a volume of said working medium exiting said first volume regulating unit differs from a volume of said working medium entering said second volume regulating unit, and a volume of said working medium entering said first volume regulating unit differs from a volume of said working medium exiting said second volume regulating unit.

2. The mechanical device as claimed in claim 1, wherein said circulation path is a closed path.

3. The mechanical device as claimed in claim 1, further comprising a transmission unit connected to said first and second volume regulating units for transferring kinetic energy to or from said first and second volume regulating units.

4. The mechanical device as claimed in claim 1, wherein at least one of said first and second volume regulating units includes at least one screw.

5. The mechanical device as claimed in claim 1, wherein at least one of said first and second volume regulating units includes at least one piston unit.

6. The mechanical device as claimed in claim 5, wherein:
said first volume regulating unit includes
a first cylinder,
a first piston unit which is movably disposed in said first cylinder, and which divides an inner space of said first cylinder into two chambers,
four tubes, two of which connect one of said chambers of said first cylinder with said hot and cold ends, respectively,
and the other two of which connect the other one of said chambers of said first cylinder with said hot and cold ends, respectively, and
four tube valves, each of which is operable to open or close a respective one of the said tubes of said first volume regulating unit;
said second volume regulating unit includes
a second cylinder,
a second piston unit which is movably disposed in said second cylinder, and which divides an inner space of said second cylinder into two chambers,
four tubes, two of which connect one of said chambers of said second cylinder with said hot and cold ends, respectively, and the other two of which connect the other one of said chambers of said second cylinder with said hot and cold ends, respectively, and
four tube valves, each of which is operable to open or close a respective one the said tubes of said second volume regulating unit;
a volume of said first cylinder is smaller than that of said second cylinder; and
said mechanical device further comprises a transmission unit connected to said first and second volume regulating units for transferring kinetic energy to or from said first and second volume regulating units.

7. The mechanical device as claimed in claim 1, wherein at least one of said first and second volume regulating units includes at least one scroll.

8. The mechanical device as claimed in claim 7, further comprising:
a first complex unit including
a first end cap that includes an end wall constituting said cold end, a first stationary scroll fixed on said end wall of said first end cap and cooperating with said end wall of said first end cap to define said first volume regulating unit, and a surrounding wall extending from an outer periphery of said end wall of said first end cap and cooperating with said end wall of said first end cap and said first stationary scroll to define a first heat exchange chamber which is in spatial communication with said first volume regulating unit, and
a first movable disc that is movably connected to said first end cap, and that includes a first movable scroll movably engaged with said first stationary scroll;
a second complex unit including
a second end cap that includes an end wall constituting said hot end, a second stationary scroll fixed on said end wall of said second end cap and cooperating with said end wall of said second end cap to define said second volume regulating unit, and a surrounding wall extending from an outer periphery of said end wall of said second end cap and cooperating with said end wall of said second end cap and second first stationary scroll to define a second heat exchange chamber which is in spatial communication with said second volume regulating unit, and
a second movable disc that is movably connected to said second end cap, and that includes a second movable scroll movably engaged with said second stationary scroll;
first and second connecting tubes, each of which connects said first movable disc with said second movable disc such that movements of said first and second movable discs are synchronized; and
a transmission unit connected to said first and second movable discs for transferring kinetic energy to or from said first and second movable discs.

9. An operating method for a mechanical device, comprising the steps of:
(a) operating a first volume regulating unit for moving a first volume of a working medium from said first volume regulating unit into thermal contact with a hot end, and simultaneously operating a second volume regulating unit for moving a second volume of said working medium from said hot end into said second volume regulating unit, such that said second volume is greater than said first volume, so as to expand said working medium during thermal contact with said hot end for heat exchange;
(b) operating said second volume regulating unit for expanding said working medium in said second volume regulating unit;
(c) operating said second volume regulating unit for moving a third volume of said working medium from said second volume regulating unit into thermal contact with a cold end, and simultaneously operating said first volume regulating for moving a fourth volume of said working medium from said cold end into said first volume regulating unit, such that said fourth volume is smaller than said third volume, so as to compress said working medium during thermal contact with said cold end for heat exchange; and
(d) operating a first volume regulating unit for compressing said working medium in said first volume regulating unit.

10. An operating method for a mechanical device, comprising the steps of:
(a) operating a second volume regulating unit for compressing a working medium in said second volume regulating unit;
(b) operating said second volume regulating unit for moving a first volume of said working medium from said second volume regulating unit into thermal contact with a hot end, and simultaneously operating a first volume regulating unit for moving a second volume of said working medium from said hot end into said first volume regulating unit, such that said second volume is smaller than said first volume, so as to compress said working medium during thermal contact with said hot end for heat exchange;
(c) operating said first volume regulating unit for expanding said working medium in said first volume regulating unit; and
(d) operating said first volume regulating unit for moving a third volume of said working medium from said first volume regulating unit into thermal contact with a cold end, and simultaneously operating said second volume regulating unit for moving a fourth volume of said working medium from said cold end into said second volume regulating unit, such that said fourth volume is greater than said third volume, so as to expand said working medium during thermal contact with said cold end for heat exchange.
